(19) United States
(12) Patent Application Publication
(10) Pub. No.: US 2014/0330742 A1
(43) Pub. Date: Nov. 6, 2014

(54) TAILORED SUBSCRIPTION CUSTOMER SAVING PROCEDURES

(71) Applicant: MICROSOFT CORPORATION, Redmond, WA (US)

(72) Inventors: Daniel William Jacobs, Dublin (IE); Pieter Kasselman, Dublin (IE); David Mowatt, Dublin (IE); Terry Farrell, Dublin (IE)

(73) Assignee: Microsoft Corporation, Redmond, WA (US)

(21) Appl. No.: 13/874,486

(22) Filed: May 1, 2013

(51) Int. Cl. G06Q 30/00

(52) U.S. Cl. CPC G06Q 30/01
USPC 705/344

(57) ABSTRACT

Representations of user input associated with one or more computer-readable customer profiles that are associated with a subscription service can be received. Additionally, a potential upcoming cancellation of a subscription to the subscription service for a subject customer profile can be detected. After the detection of the potential upcoming cancellation, a tailored customer saving procedure can be selected from among a plurality of available customer saving procedures (e.g., using a weighted algorithm and/or set selection rules). The selection of the tailored customer saving procedure can use and be based on computer-readable data representing user input associated with the one or more customer profiles. In response to the detection of the potential upcoming cancellation, the selected tailored customer saving procedure can be performed.

### BACKGROUND

Subscription components, such as goods and/or services, are often provided to customers who subscribe to a subscription service. For example, the software industry is transitioning from a model of selling boxed software to selling subscriptions to software and/or services. There are many other examples of subscriptions, such as subscriptions to physical and/or digital magazines, subscriptions to food delivery services, etc. Users can cancel subscriptions (chum), so subscription providers attempt to reduce such cancellations.

One method of reducing churn is to attempt to “save” customers who signal intent to cancel their subscription (i.e., convince the customers to change their minds and not cancel). Currently, users who attempt to cancel subscriptions over the telephone can often be convinced to remain a customer by a trained support agent on the telephone. Telephone-based support agents may achieve high save rates by providing useful information and advice to the customer. Such support agents may be able to view representations of usage data from the customer's subscription, and they can tailor their message to suit the particular customer. In scenarios where users buy subscriptions to applications or services from a centralized store (or powered by a centralized billing provider), such users may be offered a simple cancelation page where a service may be stopped at the next billing period, often with a generic message asking if the user is sure about the cancellation.

### SUMMARY

It is believed that customer save rates can be increased by increasing the sophistication and variety of ways to attempt to save the customers from subscription cancellation. The tools and techniques discussed herein relate to tailoring computer-based customer saving procedures to a particular customer who has signaled intent to cancel a subscription.

In one embodiment, the tools and techniques can include receiving representations of user input associated with one or more computer-readable customer profiles that are in turn associated with a subscription service. Additionally, a potential upcoming cancellation of a subscription to the subscription service can be detected. The subscription can be for a subject computer-readable customer profile. For example, the detection can be detecting the end of a fixed-length subscription period (e.g., a paid subscription period or a trial subscription period) or detecting receipt of a cancellation request. The cancellation request can be a request associated with the subject computer-readable customer profile (e.g., the request can identify the subject user profile, or can be provided while logged into a subscription management system using credentials for the subject user profile). The cancellation request can indicate that a subscription to the subscription service for the subject customer profile is to be cancelled. After the potential upcoming cancellation is detected, a tailored customer saving procedure can be selected from among a plurality of available customer saving procedures (e.g., using a weighted algorithm and/or set selection rules). The selection of the tailored customer saving procedure can use and be based on computer-readable data representing user input associated with the one or more customer profiles. In response to detecting the potential upcoming cancellation, the selected tailored customer saving procedure can be performed.

In another embodiment of the tools and techniques, a procedure manager computing component, which is managed by a first entity, can receive definitions of customer saving procedures from a second entity that is independent of the first entity (the definitions may completely or partially define the customer saving procedures). Representation of user input associated with one or more computer-readable customer profiles associated with a subscription service can also be received. A potential upcoming cancellation of a subscription to the subscription service for a subject computer-readable customer profile can be detected. After detecting the potential upcoming cancellation, a cancellation manager computing component can select a tailored customer saving procedure from among a plurality of available customer saving procedures that include the received customer saving procedures. The cancellation manager computing component can perform the selected tailored customer saving procedure.

This Summary is provided to introduce a selection of concepts in a simplified form. The concepts are further described below in the Detailed Description. This Summary is not intended to identify key features or essential features of the claimed subject matter, nor is it intended to be used to limit the scope of the claimed subject matter. Similarly, the invention is not limited to implementations that address the particular techniques, tools, environments, disadvantages, or advantages discussed in the Background, the Detailed Description, or the attached drawings.

### BRIEF DESCRIPTION OF THE DRAWINGS

FIG. 1 is a block diagram of a suitable computing environment in which one or more of the described embodiments may be implemented.

FIG. 2 is a block diagram of a tailored customer saving computing system or environment.

FIG. 3 is a flow diagram of a tailored customer saving technique.

FIG. 4 is a flow diagram of another tailored customer saving technique.

FIG. 5 is an illustration of a customer saving content page.

### DETAILED DESCRIPTION

As used herein, the term “entity” refers to an individual person or a company. The term company refers to a legal organization, such as a corporation, partnership, association, cooperative, etc. An entity is considered to be independent of another entity if neither entity has legal control of the other entity (as in an employer-employee relationship or as a child corporation being controlled by a parent corporation that owns a controlling interest in the child corporation), and the entities are not commonly controlled by a different entity. However, independent entities may have one or more agreements in place, such as agreements as to how a subscription service is to be operated. A computing component or system being managed by an entity refers to the entity controlling operation of the computing component or system. The managing entity may allow another entity to provide user input that affects operation of the computing component or system, but the managing entity still maintains ultimate control in operating the computing component or system. Data being managed by an entity refers to the entity controlling access to and modification of the data. The managing entity may allow another entity to access or modify the data, but the managing entity still maintains ultimate control of access and modifications to the data.

The term subscription refers to a collection of products and/or services acquired by a customer from a provider or group of providers on a time-limited basis. The term first-party subscription refers to a subscription whose subscription components are provided directly to customers by a primary provider (though the subscription components may be actually delivered via one or more couriers, computer networks, etc.). The term third-party subscription refers to a subscription whose subscription components are provided to customers by a third-party provider, but sold through the primary provider on behalf of the third-party provider. The term subscription component refers to a physical and/or digital product and/or service provided to a customer under the subscription. The terms fixed-length subscription, fixed-length subscription period and similar terms refer to a subscription that will be cancelled at a predetermined time (the end of the fixed-length subscription period) unless a customer indicates otherwise (such as by providing user input to indicate that the subscription is to continue after the end of the fixed-length subscription period). An indefinite or ongoing subscription refers to a subscription that is not a fixed length subscription (i.e., the subscription does not have a set time at which the subscription will be automatically cancelled). The term customer refers to an entity that receives subscription component(s) under the subscription. The term provider refers to an entity providing subscription components under the subscription. The term third-party provider refers to an entity providing subscription components through another company, which is referred to as a provider. The term incentive refers to an incentive offered to a customer by a computer system to encourage the customer to remain a customer, and not cancel the customer's subscription (e.g., additional subscription components, lower price, a free or reduced price extension of the period of the subscription, etc.).

The term tailored customer saving procedure refers to a procedure that provides one or more incentive offers and/or information regarding a subscription (or group of subscriptions) after detecting a potential upcoming cancellation of the subscription(s), such as in response to detecting an upcoming end to a fixed length subscription period (e.g., a paid subscription period, or a non-paid trial subscription period) or receipt of a request to cancel the subscription(s). A tailored customer saving procedure is “tailored” in that different customer saving procedures (e.g., procedures that provide different content groups that can be displayed to the customers as pages, and/or different content for those content groups) are selected for customers having different stored data associated with a customer profile (usage data regarding usage of a subscription, data indicating the customer's user input during a current cancellation experience, which may include multiple customer saving procedures, etc.). Accordingly, the system may select a first tailored customer saving procedure for a first customer having a first customer profile and may select a second tailored customer saving procedure that is different from the first tailored customer saving procedure for a second customer having a second customer profile that is different from the first customer profile (e.g., different subscription usage data). Each customer saving procedure may include a single step (e.g., providing grouped content for a single displayed page) or multiple steps (e.g., providing grouped content for multiple displayed pages, and possibly also providing conditions for flowing between those displayed pages).

Embodiments described herein are directed to techniques and tools for tailored customer saving procedures when a customer has indicated intent to cancel a subscription. Improvements may result from the use of the various techniques and tools separately or in combination.

Such techniques and tools may include dynamically generating a customer-tailored experience for a customer (user) who signals intent to cancel a subscription. When a customer enters the subscription cancellation experience, before the cancellation happens, the customer can be taken through a tailored customer saving procedure to try to convince the customer not to cancel the subscription. The techniques may include one or more of the following: monitoring customer behavior by collecting customer usage data throughout the duration of a subscription; based on data such as the usage data for a subject customer's profile and/or data representing success (e.g., rates of success or failure in saving customers from cancelling subscriptions) of previously-performed customer saving procedures for other customer profiles with particular attributes, presenting the customer with a tailored customer saving procedure when an indication of intent to cancel is received; selecting customer saving procedure(s) mid-flow based on user input received after the indication of the intent to cancel is received; and/or allowing an entity, which is independent of an entity managing the customer saving experience, to configure the customer saving experience.

One or more substantial benefits can be realized from the tools and techniques described herein. For example, a customer who has indicated intent to cancel a subscription may be presented with an automated customer saving experience that is tailored to the particular customer and that has been chosen using machine learning from results of prior customer saving experiences. This can provide the customer with tailored information and/or incentives that can result in the customer being better informed, more satisfied, and/or more likely to remain a subscription customer. Accordingly, the tools and techniques may result in increased efficiencies (by using automated computer systems that can reduce the use of live telephone operators) and reduced churn. These benefits can apply to providers and to subscription customers.

The subject matter defined in the appended claims is not necessarily limited to the benefits described herein. A particular implementation of the invention may provide all, some, or none of the benefits described herein. Although operations for the various techniques are described herein in a particular, sequential order for the sake of presentation, it should be understood that this manner of description encompasses rearrangements in the order of operations, unless a particular ordering is required. For example, operations described sequentially may in some cases be rearranged or performed concurrently. Moreover, for the sake of simplicity, flowcharts may not show the various ways in which particular techniques can be used in conjunction with other techniques.

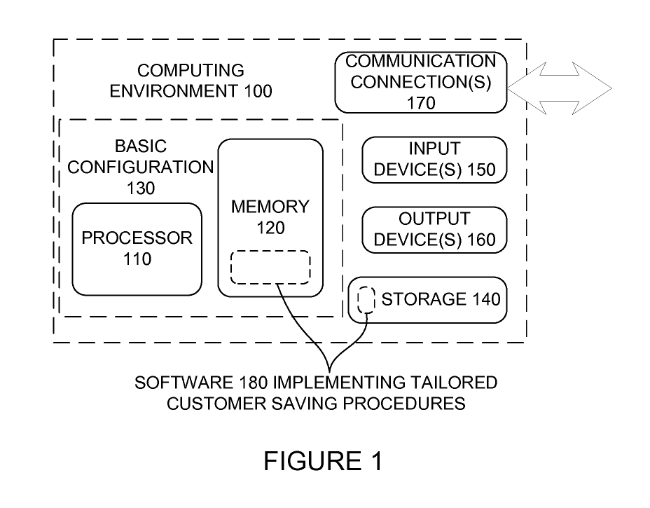

Techniques described herein may be used with one or more of the systems described herein and/or with one or more other systems. For example, the various procedures described herein may be implemented with hardware or software, or a combination of both. For example, the processor, memory, storage, output device(s), input device(s), and/or communication connections discussed below with reference to FIG. 1 can each be at least a portion of one or more hardware components. Dedicated hardware logic components can be constructed to implement at least a portion of one or more of the techniques described herein. For example and without limitation, such hardware logic components may include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc. Applications that may include the apparatus and systems of various embodiments can broadly include a variety of electronic and computer systems. Techniques may be implemented using two or more specific interconnected hardware modules or devices with related control and data signals that can be communicated between and through the modules, or as portions of an application-specific integrated circuit. Additionally, the techniques described herein may be implemented by software programs executable by a computer system. As an example, implementations can include distributed processing, component/object distributed processing, and parallel processing. Moreover, virtual computer system processing can be constructed to implement one or more of the techniques or functionality, as described herein.

### I. Exemplary Computing Environment

FIG. 1 illustrates a generalized example of a suitable computing environment (100) in which one or more of the described embodiments may be implemented. For example, one or more such computing environments can be used as a client computer system, a cancellation manager, a data store, a data collector, and/or a subscription component provider. Generally, various different general purpose or special purpose computing system configurations can be used. Examples of well-known computing system configurations that may be suitable for use with the tools and techniques described herein include, but are not limited to, server farms and server clusters, personal computers, server computers, smart phones, laptop devices, slate devices, game consoles, multiprocessor systems, microprocessor-based systems, programmable consumer electronics, network PCs, minicomputers, mainframe computers, distributed computing environments that include any of the above systems or devices, and the like.

The computing environment (100) is not intended to suggest any limitation as to scope of use or functionality of the invention, as the present invention may be implemented in diverse general-purpose or special-purpose computing environments.

With reference to FIG. 1, various illustrated hardware-based computer components will be discussed. As will be discussed, these hardware components may store and/or execute software. The computing environment (100) includes at least one processing unit or processor (110) and memory (120). In FIG. 1, this most basic configuration (130) is included within a dashed line. The processing unit (110) executes computer-executable instructions and may be a real or a virtual processor. In a multi-processing system, multiple processing units execute computer-executable instructions to increase processing power. The memory (120) may be volatile memory (e.g., registers, cache, RAM), non-volatile memory (e.g., ROM, EEPROM, flash memory), or some combination of the two. The memory (120) stores software (180) implementing one or more aspects of tailored customer saving procedures. An implementation of tailored customer saving procedures may involve all or part of the activities of the processor (110) and memory (120) being embodied in hardware logic as an alternative to or in addition to the software (180).

Although the various blocks of FIG. 1 are shown with lines for the sake of clarity, in reality, delineating various components is not so clear and, metaphorically, the lines of FIG. 1 and the other figures discussed below would more accurately be grey and blurred. For example, one may consider a presentation component such as a display device to be an I/O component (e.g., if the display device includes a touch screen). Also, processors have memory. The inventors hereof recognize that such is the nature of the art and reiterate that the diagram of FIG. 1 is merely illustrative of an exemplary computing device that can be used in connection with one or more embodiments of the present invention. Distinction is not made between such categories as “workstation,” “server,” “laptop,” “handheld device,” etc., as all are contemplated within the scope of FIG. 1 and reference to “computer,” “computing environment,” or “computing device.”

A computing environment (100) may have additional features. In FIG. 1, the computing environment (100) includes storage (140), one or more input devices (150), one or more output devices (160), and one or more communication connections (170). An interconnection mechanism (not shown) such as a bus, controller, or network interconnects the components of the computing environment (100). Typically, operating system software (not shown) provides an operating environment for other software executing in the computing environment (100), and coordinates activities of the components of the computing environment (100).

The storage (140) may be removable or non-removable, and may include computer-readable storage media such as flash drives, magnetic disks, magnetic tapes or cassettes, CD-ROMs, CD-RWs, DVDs, or any other medium which can be used to store information and which can be accessed within the computing environment (100). The storage (140) stores instructions for the software (180).

The input device(s) (150) may be one or more of various different input devices. For example, the input device(s) (150) may include a user device such as a mouse, keyboard, trackball, etc. The input device(s) (150) may implement one or more natural user interface techniques, such as speech recognition, touch and stylus recognition, recognition of gestures in contact with the input device(s) (150) and adjacent to the input device(s) (150), recognition of air gestures, head and eye tracking, voice and speech recognition, sensing user brain activity (e.g., using EEG and related methods), and machine intelligence (e.g., using machine intelligence to understand user intentions and goals). As other examples, the input device(s) (150) may include a scanning device; a network adapter; a CD/DVD reader; or another device that provides input to the computing environment (100). The output device(s) (160) may be a display, printer, speaker, CD/DVD-writer, network adapter, or another device that provides output from the computing environment (100). The input device(s) (150) and output device(s) (160) may be incorporated in a single system or device, such as a touch screen or a virtual reality system.

The communication connection(s) (170) enable communication over a communication medium to another computing environment. Additionally, functionality of the components of the computing environment (100) may be implemented in a single computing machine or in multiple computing machines that are able to communicate over communication connections. Thus, the computing environment (100) may operate in a networked environment using logical connections to one or more remote computing devices, such as a handheld computing device, a personal computer, a server, a router, a network PC, a peer device or another common network node. The communication medium conveys information such as data or computer-executable instructions or requests in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

The tools and techniques can be described in the general context of computer-readable media, which may be storage media or communication media. Computer-readable storage media are any available storage media that can be accessed within a computing environment, but the term computer-readable storage media does not refer to propagated signals per se. By way of example, and not limitation, with the computing environment (100), computer-readable storage media include memory (120), storage (140), and combinations of the above.

The tools and techniques can be described in the general context of computer-executable instructions, such as those included in program modules, being executed in a computing environment on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing environment. In a distributed computing environment, program modules may be located in both local and remote computer storage media.

For the sake of presentation, the detailed description uses terms like “receive,” “send,” “perform,” “execute,” and “select” to describe computer operations in a computing environment. These and other similar terms are high-level abstractions for operations performed by a computer, and should not be confused with acts performed by a human being or group of human beings, unless performance of an act by a human being (such as a “user”) or group of human beings is explicitly noted. The actual computer operations corresponding to these terms vary depending on the implementation.

### II. Tailored Customer Saving System and Environment

A. Tailored Customer Saving System Computing Environment Components

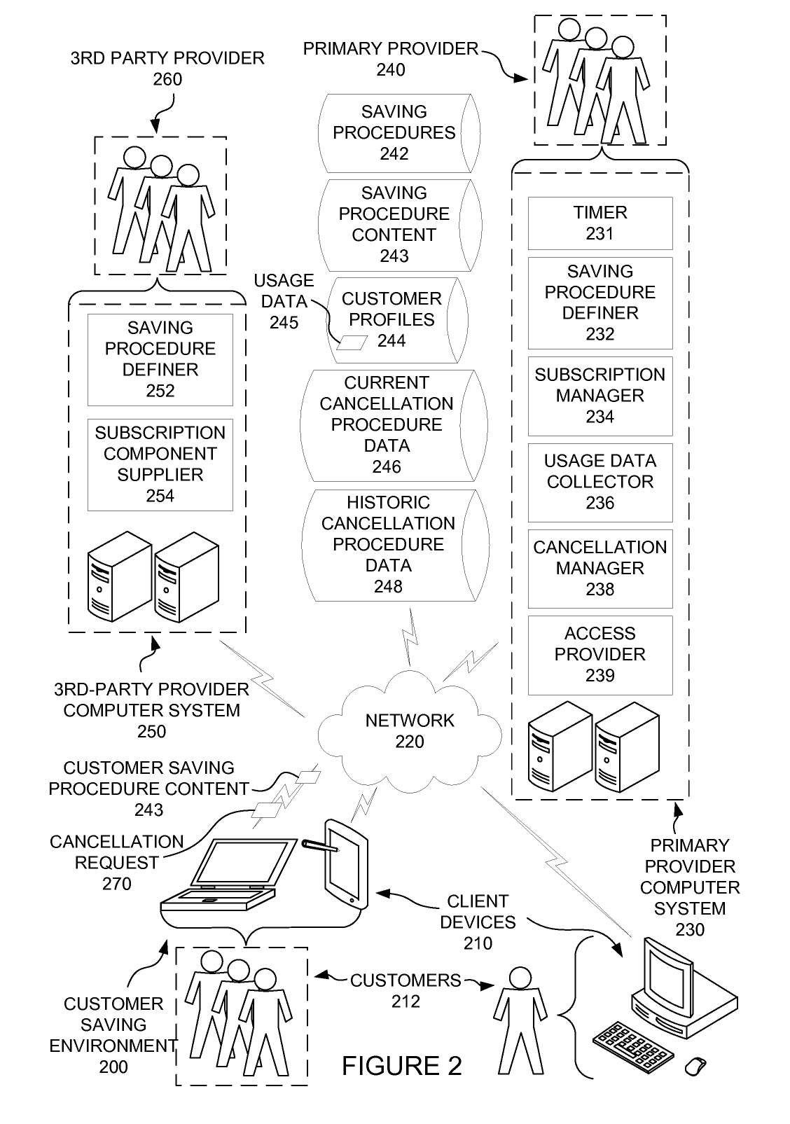

FIG. 2 is a block diagram of a tailored customer saving computing system or environment (200) in conjunction with which one or more of the described embodiments may be implemented. The environment (200) can include client devices (210), which can each be one or more computing environments. The client devices (210) can present information to and receive user input from customers (212), which can be customers of a subscription service that is being managed in the customer saving environment (200). Each customer (212) can be a single entity or a group of entities (e.g., a group of people such as a family on a group subscription plan). Each customer (212) may interact with a single client device (210) or with multiple client devices (210). Additionally, multiple customers (212) may interact with a single client device (210).

The client devices (210) are connected to a computer network (220). The network (220) is illustrated as a single component in FIG. 2. However, the network (220) may include multiple networks that are interconnected, such as local area networks, wide area networks, a global computer network, etc.

A primary provider computer system (230) can also be connected to the network (220), so that the primary provider computer system (230) can communicate with the client devices (210). The primary provider computer system (230) and the other computing components of the customer saving environment (200) can include computing components that run on computer hardware, such as the hardware discussed above with reference to FIG. 1. These computing components can include a timer (231), a saving procedure definer (232), a subscription manager (234), a usage data collector (236), and a cancellation manager (238). The primary provider computer system (230) can be managed by an entity, which is termed a primary provider (240). Additionally, the primary provider computer system (230) can access various types of computer-readable data, which may be stored in storage hardware within the primary provider computer system (230) or elsewhere. This data can include customer saving procedures (242), customer saving procedure content (243) that can be provided as part of performing the customer saving procedures (242), customer profiles (244) that can include customer subscription usage data (245), current cancellation procedure data (246), and historic cancellation procedure data (248).

The customer saving environment (200) can also include a third-party provider computer system (250), which can include various components, such as a saving procedure definer (252) and a subscription component supplier (254). The third-party provider computer system (250) can be managed by an entity that is termed a third-party provider (260).

B. Description of the Features of the Customer Saving Environment

The types of data (242, 243, 244, 246, and 248), and the components of the provider computer systems (230 and 250) will now be discussed.

The customer saving procedures (242) can include definitions of procedures that define flows between different content groupings of the saving procedure content (243). For example a content grouping may include content that can be formatted and sent as a group of data that is configured to be displayed as a page on a computer display (e.g., as a dialog, a Web page, etc.). The content may include informational content, as well as user input controls that can be selected by user input to invoke various actions (accepting an offer for an incentive, confirming intent to cancel a subscription, etc.). In one example, a customer saving procedure may automatically provide an incentive, without an incentive offer needing to be accepted by user input from the customer. For example, an automatic extension of a period of the subscription may be provided for free without requiring any user input from the customer to accept this automatic incentive offer. In this situation, content may be provided to inform the customer of the free extension.

Additionally, the customer saving procedures (242) may include logic that dictates what to do with the other types of data (244, 246, and 248), etc. For example, the customer saving procedures (242) may dictate what level of an incentive offer to give a customer (212) having a given customer loyalty value (which is discussed more below), or even to a particular customer (212). For example, the customer saving environment (200) may support a standardized format for mapping the level of incentive (how much of a price increase or how much in additional subscription components) to provide to a customer based on their customer loyalty value score. The third-party provider computer system (250) may send the primary provider computer system (230) an incentives file for a particular subscription. Such an incentives file may include customer saving procedures (242) and/or customer saving procedure content (243) for that subscription. For example, the primary provider computer system (230) can use this incentives file to determine which level of incentive to provide to the customer (212) if/when the customer (212) signals intent to cancel their subscription. This file may be updated, and it may define an incentive level in terms of other data that may change (e.g., in terms of a customer loyalty value).

The customer saving procedures (242) and/or the customer saving procedure content (243) may be defined by a saving procedure definer (232) in the primary provider computer system (230) and/or by a saving procedure definer (252) in the third-party provider computer system. The saving procedure definers can take various forms. For example, a saving procedure definer (232 or 252) may be part of a mobile or desktop application that provides an interactive application user interface, which may be constructed with user interface elements, through which user input can be provided to define the customer saving procedures (242). As another example, a saving procedure definer (232) may be a user interface in the form of a Web page that can be displayed with a Web browser and includes interactive features that allow user input to be provided to define customer saving procedures (242). For example, the saving procedure definer (232) in the primary provider computer system (230) may control the definitions of the customer saving procedures (242) and/or customer saving procedure content (243), but may provide a dashboard-type user interface through which the third-party provider computer system (250) can receive user input from the third-party provider (260) and define the customer saving procedures (242) and/or customer saving procedure content (243) by modifying the existing customer saving procedures (242) and/or customer saving procedure content (243), or by defining new customer saving procedures (242) and/or customer saving procedure content (243).

The dashboard-type user interface can also display representations of the different types of data (242, 243, 244, 246, and/or 248) for customers (212) of the third-party provider (260), or the third-party provider (260) may be provided with access to the different types of data (242, 243, 244, 246, and/or 248) in some other manner. Either way, the primary provider computer system (230) may include an access provider (239), which can provide an access portal (a Web-based portal or some other type of portal) to allow the third-party provider computer system (250) to access the different types of data (242, 243, 244, 246, and/or 248) for the customers (212) of the third party provider (260). The primary provider computer system (230) may interact with multiple third party providers similarly to the third party provider (260). However, the access of the third party provider (260) may be limited to information pertaining to that third party provider's customers (212). Alternatively, the third party provider (260) may be provided with access to some general information related to other customers (e.g., information on save rates for a customer saving procedure for all customers (212) of the primary provider (240) and/or other third party providers), not just the customers for that third party provider (260)). The access provided to the third party provider (260) can allow the third party provider (260) to provide modified definitions of the saving procedures (242) (e.g., modified flows and/or content) and/or allow the saving procedure definer (252) to automatically provide modified definitions of the saving procedures (242) to enhance performance of the customer saving procedures (242) within the parameters of what the third party provider (260) deems valuable.

Even if the saving procedure definer (252) in the third party provider computer system (250) is expected to provide definitions of the customer saving procedures (242) (which can include logical flows and content for the procedures), the saving procedure definer (232) in the primary provider computer system (230) may provide definitions of default customer saving procedures (242). The cancellation manager (238) can determine whether the saving procedure definer (252) has provided customer saving procedures (242). If not, then the cancellation manager can use the default customer saving procedures (242).

The customer profiles (244) can include profile information for each customer (212) that has one or more active subscriptions to the subscription service being provided by the third-party provider (260) and/or the primary provider (240). For example, this profile information may include identifying information for a corresponding customer (212); information about credentials to be used by the customer (212) to manage the subscription(s), such as through client devices (210) and the primary provider computer system (230); information about the status of the subscription(s) for the customer (212); and/or information about usage of one or more subscriptions of the subscription service by the customer (212). While the description herein generally refers to cancellation of a single subscription by a customer (212), this is done for the sake of convenience and clarity in the description. The tools and techniques herein also apply to attempts to save a customer who has signaled intent to cancel multiple subscriptions at the same time, and to a customer who has signaled intent to cancel a subset (one or more) of multiple subscriptions that are associated with a single user profile.

Management of a subscription can be facilitated by a subscription manager (234) in the primary provider computer system (230). The subscription manager (234) can facilitate providing subscription components to the customers (212), such as by initiating providing of such subscription components. For example, the subscription manager (234) may provide or authorize the providing of software from the third-party provider computer system or from the primary provider computer system. For example, such software could be provided by the subscription component supplier (254) in the third-party provider computer system (250) to the primary provider computer system (230) and from the primary provider computer system (230) to a client device (210). Alternatively, the subscription component supplier (254) can provide such software to the client device (210) without the software going through the primary provider computer system (230). This may occur even if the subscription was sold by the primary provider computer system (230).

The usage data collector (236) can collect usage data (245) representing usage of the subscription by the customers (212). For example, the usage data collector (236) may collect information about subscription components the customer (212) uses, how long and how often a customer (212) has been using each subscription component, which features of individual subscription components the customer (212) has been using, the number of times the customer (212) has called technical support, the payment method used by the customer (212), etc. For example, the usage data collector (236) may monitor the amount of the customer's use of particular software features for a software subscription. As another example, if the subscription is for food delivery, where the customer (212) can periodically order different types of food provided by the subscription, the usage data collector (236) can collect information about amounts and types of food ordered by the customer (212). As other examples, the usage data collector (236) may collect data points representing how long the customer (212) has had the subscription, the percentage of timely payments made by the customer (212), etc. The usage data collector (236) can store such usage information in the corresponding customer profile (244). The usage data collector (236) or the cancellation manager (238) may use such information in various ways. For example, the usage data collector (236) or the cancellation manager (238) may aggregate the usage information in the customer profile (244) to generate a customer loyalty value, which can represent the loyalty of the customer (212) corresponding to the customer profile (244) (e.g., customers (212) who have been with a company longer can be considered to be more loyal customers, customers (212) who call customer support an inordinate amount of times may be considered less loyal, customers (212) with automatic payment and renewal may be considered more loyal, customers (212) who use subscription components more often may be considered more loyal, customers who share and/or collaborate more with others (e.g., through subscription components provided by the subscription or in other detectible ways), etc.).

The cancellation manager (238) can manage subscription cancellation and customer saving procedures (242). For example, the cancellation manager (238) or some other computing component can detect a potential upcoming cancellation of a subscription. For example, the timer (231) may detect an upcoming end to a fixed-length subscription period. In one example, the timer can periodically poll subscription period information, such as information stored with the customer profiles (244), and can determine whether an end to a subscription period is scheduled to occur within a predetermined period of time (e.g., within three days, within one week, within one month, etc.). This predetermined period of time can be modifiable and may be defined by user input, such as user input provided through the saving procedure definer (232) and/or the saving procedure definer (252). If an end to a fixed-length subscription is scheduled occur within the predetermined period of time from the present time, the timer (231) can inform the cancellation manager (238) of this situation. As another example of detecting an upcoming potential cancellation, the cancellation manager (238) can receive a cancellation request (270) (which can be a message indicating intent to cancel the subscription) from a client device (210). The cancellation manager (238) can respond to detection of an upcoming potential cancellation by selecting and performing a tailored customer saving procedure (242). The selection of this customer saving procedure can depend on various factors, such as the customer's loyalty value for the corresponding customer profile (244), the customer's usage data (245), and user input responses from the customer during the current cancellation experience, which can be represented in the current cancellation procedure data (246).

For example, the flow of the cancellation experience may include sending customer saving procedure content (243) to a client device (210). The customer saving procedure content (243) may be provided in any of various ways, which may be different depending on various factors, such as whether the customer saving procedure (242) is being performed in response to a cancellation request (270). For example, if the customer saving procedure (242) is being performed in response to a cancellation request (270) that was sent in response to user input selecting a cancellation request control on a Web page, then the customer saving procedure content (243) may be provided in the form of content that is configured to be displayed as a Web page (such as data in a markup language format). As another example, if the customer saving procedure (242) is being performed in response to detecting that a fixed-length subscription period is about to expire, then at least a portion of the customer saving procedure content (243) may be sent in one or more messages, such as an email message. A customer (212) may provide user input to respond to such a message by selecting a link in the message, sending another message in response, or in some other manner. For example, an email message may include a link and/or textual address for a Web page that can be selected to prompt the primary provider computer system (230) to provide more customer saving procedure content (243) formatted to be displayed as a Web page, which may provide the customer (212) with additional information and/or allow the customer (212) to provide additional information and/or requests.

The customer saving procedure content (243) can include a response with an initial survey, which can inquire as to the reason the customer (212) wishes to cancel. The remainder of the cancellation experience may be partially or entirely determined by the user input provided by the customer and received by the primary provider computer system (230). For example, if the user input indicates that the customer (212) wishes to cancel because they are experiencing technical difficulties with the subscription, the selected customer saving procedure (242) may send customer saving procedure content (243) that is configured to display a page on the client device (210), and the page can direct the customer to contact technical support to fix the technical problem, instead of immediately cancelling the subscription. As another example, if the user input indicates that the customer (212) can no longer afford to subscribe, the selected customer saving procedure (242) may provide customer saving procedure content (243) that offers an incentive in the form of a reduced price for the subscription to ease the financial burden of continuing to subscribe.

In selecting a customer saving procedure (242), the cancellation manager (238) may execute a weighted algorithm. For example, the cancellation manager (238) may provide a query to a search service that runs the weighted algorithm, or the cancellation manager (238) may run the algorithm itself. The weighted algorithm may use historic cancellation procedure data (248) in running the weighted algorithm. The historic cancellation procedure data (248) can include data representing saving procedures that were used with prior customers (212), such as customers who had signaled intent to cancel their subscriptions. The historic cancellation procedure data (248) may also include customer profile information about such customers (212) (such as usage data (245) for such customers) and whether the customer saving procedure (242) was successful in saving the customer (212). Additionally, the historic cancellation procedure data (248) may include data representing interactions with the customers (212) during the customer saving procedures. For example, if a customer (212) is presented with an offer, the customer (212) may be allowed to provide user input to choose to view additional information on an offer, or may choose to view the offer, or the customer (212) may take no action at all. The input or lack of input from the customer (212) can be recorded in the historic cancellation procedure data (248) and used to gauge customer interest in that offer. The cancellation manager (238) can also save current cancellation procedure data (246), which can monitor information about the current cancellation procedure. For example, the current cancellation procedure data can identify customer saving procedures that have already been tried in response to the current detection of an upcoming potential cancellation, as well as user input received from the client device (210) (e.g., user input indicating a reason for the intent to cancel). The selection of a customer saving procedure (242) may also user other information, such as time of day or date in which the customer saving procedure (242) is to be performed (e.g., more generous offers provided in one month that in another month), or the geographic location where the customer (212) is or is likely to be at the time the customer saving procedure (242) is to be performed.

Another selection procedure may be used in addition to or instead of the weighted algorithm. For example, such an algorithm may be based on set rules that select particular tailored customer saving procedures if corresponding conditions are met. For example, a certain incentive may always be offered if a customer has at least a predetermined minimum customer loyalty value. As another example, a reminder of a certain subscription component may always be presented if the customer's use of the subscription component exceeds a predetermined level. Many other examples are also possible.

In one example using the weighted algorithm, the cancellation manager (238) can submit a query to the weighted algorithm, which can search the historic cancellation procedure data (248) for customer saving procedures (242). The query can include data from the customer profile (244) for the customer (212), as well as current cancellation procedure data (246). The weighted algorithm can use this information in weighted ranking features to provide overall rankings of customer saving procedures (242), with higher rankings being provided for customer saving procedures (242) that have been more successful in saving prior customers (212) whose customer profiles (244) and current cancellation procedure data (246) are a closer match to those of the current customer (212). The weights and features of the weighted algorithm may be tuned using historical data, and may be continually and/or repeatedly updated as data from new cancellation procedure results is received and analyzed. Also, a particular saving procedure (242) may contain default weights that may or may not be adjusted over time. For example, a third party provider (260) may provide these weights through the saving procedure definer (252) in the third-party provider computer system (250). As an example of this, the third party provider (260) may experiment with a new procedure, but only using 5% of their cancelling customers, while the other 95% will not experience the new procedure.

In addition to the weighting, other rules may also be used. For example, rules may be used to prevent abuse of the customer saving environment by users who do not intend to cancel, but are merely hoping to gain the incentives that may be provided by the customer saving environment. As one example, different incentives may be provided to customers, depending on their customer loyalty value, which can be calculated from their usage data (245). For example, greater price discounts or greater increases in subscription components may be offered to customers with higher customer loyalty values if those customers do not proceed to cancel their subscriptions. The identity of such incentives may be included in particular customer saving procedures (242), which may be selected by the weighted algorithm. As another example, the use of one or more incentives may be discontinued for a period of time if the cancellation manager (238) identifies a spike in the number of cancellation requests, especially if the senders of such requests do not appear to actually be intending to cancel their subscriptions.

If the customer (212) continues to signal intent to cancel after a customer saving procedure (242) is performed, the cancellation manager (238) may select and provide an additional customer saving procedure (242). However, this repeating of the selection and performance of customer saving procedures (242) can be cut off to allow the customer to actually cancel the subscription (providing the final cancellation confirmation) before a determined point of customer annoyance. The amount of repetition before such a point may be determined using focus groups and/or customer surveys, analyzing the historic cancellation procedure data (248), etc.

After using a customer saving procedure, the results of the procedure (such as whether the procedure resulted in the customer (212) being saved) can be logged in the historic cancellation procedure data (248). In addition to or instead of such logging of the result of each use of a customer saving procedure (242), calculations can be made using the results. For example, the cancellation manager (238) may calculate overall values, such as a rates of success for a customer saving procedure (242) in saving customers (212) with a given set of one or more attributes (e.g., particular values or ranges of values representing usage) of their customer profiles (244). Accordingly, as customer saving procedures (242) are used for customers (212) and the results are logged in the historic cancellation procedure data (248), the historic cancellation procedure data (248) changes. Additionally, the weights used in a weighted algorithm can change over time as the computer systems and/or users of the computer systems optimize those weights. Accordingly, the technique for selection of customer saving procedures (242) can change over time as the systems (230 and/or 250) learn from the results of using the customer saving procedures (242).

As one example of the computer systems (230 and/or 250) learning from the historic cancellation procedure data (248), in some situations it may be found that a particular customer saving procedure (242) has a success rate below a predetermined minimum value (e.g., below a 5% success rate, etc.). If this happens, the primary provider computer system (230) may be configured to automatically suspend the use of that ineffective customer saving procedure (242). The primary provider computer system (230) and/or the third-party provider computer system (250) may also present various notifications to system users, such as by displaying a notification that a particular customer saving procedure (242) has been suspended.

While the customer saving environment (200) is illustrated with various components being separated for purposes of illustration and discussion herein, such separation should not be taken as requiring a particular configuration. The distinctions between such components may be blurred and functions of multiple components may be separated or combined into various configurations of storage units, programs, functions, hardware logic components, etc. For example, one or more of the types of data (242, 244, 246, and 248) could be combined into a single database, or each type of data could be in a separate database. As another example, the subscription manager (234) and the usage data collector (236) could work together as a single component. Also, the customer saving environment (200) can operate with a primary provider computer system (230) and a primary provider (240) without the involvement of a third-party provider computer system (250) or a third-party provider (260), with the primary provider (240) and the primary provider computer system (230) providing the subscription components, customer saving procedures, etc.

It is noted that steps can be taken to protect user privacy in the operation of the customer saving environment (200). For example, security measures can be implemented to protect the different types of data (242, 244, 246, and 248). As another example, the third-party provider computer system (250) may be provided some access to the collected data (2452, 244, 246, and 248), but such access may be limited, and customers (212) may be given an opportunity to opt out of (or not opt into) having their data shared with the third-party provider computer system (250). Also, some data may be stripped of sensitive personal identifying information (e.g., such sensitive identifying information about the customer (212) may be omitted from the historic cancellation procedure data (248)). As yet another example, a customer may be given an opportunity to opt into or out of collection and/or storage of at least some types of data.

C. Examples of Using the Customer Saving Environment

An example of using the customer saving environment (200) will now be discussed. In this example, a customer (212) corresponding to a customer profile (244) can use the subscription. Meanwhile, the usage data collector (236) can monitor the customer's use of the subscription and store collected data in the customer profile (244). For example, for a software subscription, a server may provide data based on its interactions with client devices (210) associated with the customer profile (e.g., where the customer profile (244) is logged into a subscription management account or is using subscription components provided by the server). As another example, if the subscription service involves installing software on the client device (210), that software may include a component that collects data and sends the data from the client device (210) to the usage data collector (236) in the primary provider computer system (230). Accordingly, usage of individual features of subscription components can be monitored. For example, the usage data (245) collected by the usage data collector (236) can indicate if a particular customer (212) uses features A and B extensively, but has not used feature C.

Based on the usage data (245), a customer loyalty value may be computed for that customer (212). The cancellation manager (238) can detect an upcoming potential cancellation of a subscription for the customer (212). For example, the customer (212) can signal intent to cancel by providing user input to a client device (210), which can send a cancellation request (270) to the cancellation manager (238) in the primary provider computer system (230).

The primary provider computer system can respond by querying the data (242, 244, 246, and/or 248) to find out what to do next. For example, the cancellation manager (238) may execute a weighted algorithm by providing a query that is to be run with the weighted algorithm. This query can use the customer's customer loyalty value score, usage data (245), and previous survey responses to determine what next to display to the customer before the cancellation manager (238) sends the client device (210) a final “cancel confirmation” page, which allows the customer (212) to provide user input to actually cancel the subscription without further user input from the customer (212).

Types of page content (243) that could be specified by a selected customer saving procedure (242) may include, but are not limited to one or more of the following:
Tailored reminder of value of subscription: Based on the customer's known usage data (245), remind the customer (212) of the benefits of the subscription components and features that the customer (212) most frequently uses and would miss the most if the customer (212) were to cancel the subscription.
Survey: The survey can provide a user input control, asking for user input indicating why the customer wishes to cancel. User input provided in response can then be stored in the current cancellation procedure data (246) and be used to better tailor messages and offers given to the customer (212) as part of additional customer saving procedures (242) during the cancellation experience.
Merchandising offer page: If the customer's customer loyalty value score is sufficiently high, the customer (212) may be eligible for an incentive offer, which may, for example, be a lower price for the customer's existing subscription, additional subscription components, and/or additional features for the subscription components.
Support contact page: If the customer (212) has signaled that the customer is experiencing some technical problem, the selected customer saving procedure (242) may provide information configured to be displayed as a page on the client device (210) directing the customer to contact support and providing contact information for customer support. Customer support may be able to fix the problem, thus making the customer (212) less likely to cancel.
The final cancellation confirmation page: The customer saving procedure (242) may provide data for such a confirmation page if the customer loyalty value score is very low and/or if all other customer saving options have been exhausted and the customer (212) continues to signal desire to cancel. Such a page can allow the customer (212) to provide the final cancellation user input so that the subscription will be cancelled without further user input from the customer (212).

The customer (212) may choose an option presented by one of these pages, or the customer (212) may indicate by user input into the client device (210) that the customer still wishes to cancel. If the customer (212) does still wish to cancel, the cancellation manager (238) can execute another query to find out what to do next. The results of the query can indicate another customer saving procedure (242) to run, which may or may not provide the final cancel confirmation page.

### III. Tailored Customer Saving Procedure Techniques

Several tailored customer saving procedure techniques will now be discussed. Each of these techniques can be performed in a computing environment. For example, each technique may be performed in a computer system that includes at least one processor and memory including instructions stored thereon that when executed by at least one processor cause at least one processor to perform the technique (memory stores instructions (e.g., object code), and when processor(s) execute(s) those instructions, processor(s) perform(s) the technique). Similarly, one or more computer-readable storage media may have computer-executable instructions embodied thereon that, when executed by at least one processor, cause at least one processor to perform the technique. The techniques discussed below may be performed at least in part by hardware logic. Additionally, one, some, or all of the acts in the techniques may be performed automatically by computer system components.

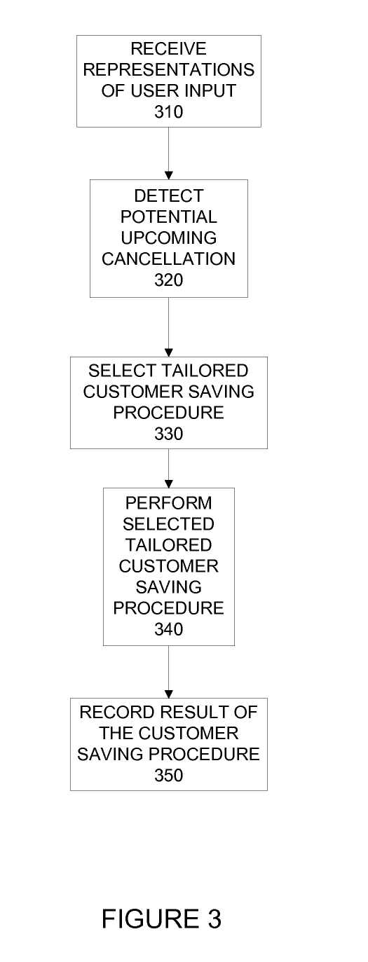

Referring to FIG. 3, a tailored subscription customer saving technique will be described. The technique can include receiving (310) representations of user input associated with one or more computer-readable customer profiles. The representations of the user input can include historic cancellation data that includes indicators of success of previously-performed customer saving procedures. For example, the indicators of success may be indicators of success and/or failure for user profiles with particular attributes. A cancellation manager computing component or some other computing component can detect (320) a potential upcoming cancellation of a subscription for a subject computer-readable customer profile. After the detection (320) of the potential upcoming cancellation, the cancellation manager computing component can select (330) a tailored customer saving procedure from among a plurality of available customer saving procedures. For example, selecting (330) the tailored customer saving procedure can include executing a weighted algorithm. The execution of the weighted algorithm can use computer-readable data representing the user input associated with the one or more customer profiles. This computer-readable data may include the representations of the associated with the one or more customer profiles, which can include the historic cancellation data. The historic cancellation data can include indicators of success of previous performances of customer saving procedures of the available customer saving procedures. In response to the detection of the potential upcoming cancellation, the cancellation manager computing component can perform (340) the selected tailored customer saving procedure (e.g., by initiating the procedure and/or fully performing the procedure). The technique may also include recording (350) a result of the selected tailored customer saving procedure in the historic cancellation data, such as by recording the result itself and/or modifying one or more values (e.g., success rate value(s)) to represent the result. This procedure can provide one or more benefits in the form of increased efficiency for a subscription provider by providing a computer-based customer saving technique, reduced chum for the subscription provider by providing tailored customer saving procedures, and/or increased customer satisfaction as a result of the customer saving procedures. As noted above, however, the claims herein are not necessarily limited to such benefits.

Execution of the weighted algorithm may be modified over time. This modification may be in response to user input directing such modification (e.g., from a primary provider and/or third party provider), or the modification may occur automatically, such as in response to additional results being recorded in the historic cancellation data. For example, such a modification may include changing a function that computes a rank of a given pair of saving procedure(s) and content for a given user profile and a given set of historical data, and/or changing weight(s) of one or more inputs to the computing function. As a specific example, a weighted algorithm may function and be weighted to more strongly prefer a customer saving procedure when that procedure's save rate is very high, or to more strongly prefer a customer saving procedure when that procedure's average revenue per saved customer is very high, or to provide equal weight to these two factors. The selection (330) of the tailored customer saving procedure can be based at least in part on a measure of customer loyalty that is based at least in part on subscription usage data from the subject customer profile. Accordingly, the technique may also include calculating the measure of customer loyalty (such as a customer loyalty value) using the subscription usage data from the subject customer profile.

The available customer saving procedures can reference content groupings to be provided by the customer saving procedures. Each of the content groupings can include a set of content items. The set of content items for a grouping of the content items can be customizable such that content for the grouping can be selected from multiple different content options, the selection of content can depend on the computer-readable data. Additionally, performing (340) the selected tailored customer saving procedure can include sending the selected content in a format that is configured to be displayed as a page on a computer display. The selection (330) of the selected tailored customer saving procedure can include selecting the grouping and selecting the content for the grouping, such as by making such a selection with the weighted algorithm.

The computer-readable data can include profile data for the subject customer profile. For example, the profile data can include usage data representing use of subscription components provided under the subscription, such as usage by the subject customer profile and/or one or more other beneficiary profiles (such as usage by profiles for multiple family members under a family subscription associated with a main customer profile for one of the family members). The computer-readable data may include data representing past user input received in association with multiple customer profiles during customer saving procedures of the available customer saving procedures, and the multiple customer profiles may include customer profiles other than the subject customer profile.

The technique may further include the cancellation component being managed by a first entity. Definitions of least a portion of the available customer saving procedures can be received from a second entity that is independent of the first entity. The receiving of the definitions can include receiving content and/or logical flows (flows between different content groupings, pages, etc., which can include conditions for such flows) for the set of available customer saving procedures. The receiving of the definitions may include receiving one or more weights for the weighted algorithm to use in selecting from the customer saving procedures. The second entity may be provided with partial or full access to the usage data representing the subject customer profile's use of subscription components provided under the subscription. Also, the second entity may be provided with one or more representations of at least a portion of the historic cancellation data, which may be managed by the first entity.

The acts may further include collecting at least a portion of the computer-readable data by monitoring user input associated with the one or more customer profiles while the one or more customer profiles are using the subscription service (i.e., one or more customers are using their customer profile(s) to use the subscription service).

Additionally, the computer-readable data may indicate subscription components of the subscription, which have been utilized in association with the subject customer profile and will no longer be available in association with the customer profile if the subscription is cancelled. Performing (340) the selected tailored customer saving procedure can include providing content in a format that is configured to be displayed as a page on a computer display. The content can indicate the utilized subscription components.

Performing (340) the selected tailored customer saving procedure can include offering the subject customer profile an incentive that includes a reduced subscription price if the subscription for the subject customer profile is not cancelled. Performing (340) the selected tailored customer saving procedure can include offering the subject customer profile an incentive if the subscription is not cancelled. The incentive can include addition subscription components that were not previously provided under the subscription for the subject customer profile.

The computer-readable data may include data representing user input received in association with the customer profile after the detection of the potential upcoming cancellation.

Moreover, the tailored customer saving procedure may be termed a first tailored customer saving procedure, and the plurality of available customer saving procedures may be termed a first set of customer saving procedures. The technique may further include the cancellation manager computing component receiving a cancellation request in response to the first customer saving procedure. After receiving the cancellation request, the cancellation manager computing component may perform the weighted algorithm to select a second tailored customer saving procedure from among the set of available customer saving procedures. The weighted algorithm can use the computer-readable data representing the user input associated with one or more customer profiles to select the second tailored customer saving procedure. Additionally, the cancellation manager computing component can perform the selected second tailored customer saving procedure. The acts of this paragraph may be repeated for a third customer saving procedure, etc., until a final confirmation of cancellation is received from the customer.

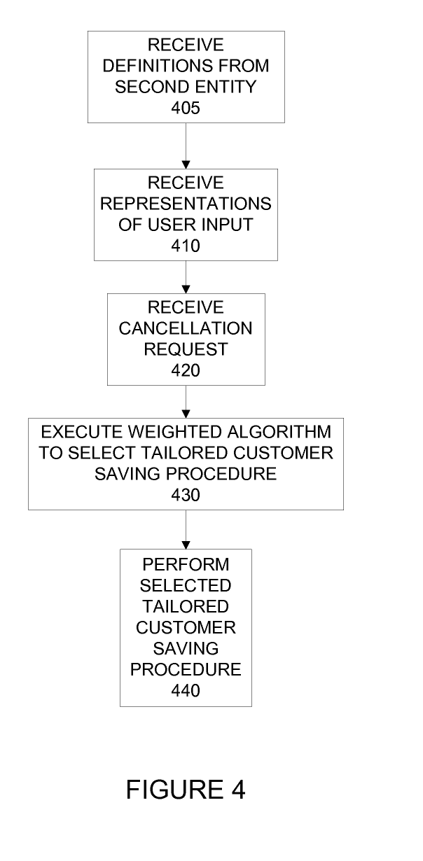

Referring to FIG. 4, another tailored subscription customer saving technique will be described. The technique can include a procedure manager computing component, which is managed by a first entity, receiving (405) definitions of received customer saving procedures from a second entity that is independent of the first entity. Representations of user input associated with one or more computer-readable customer profiles associated with a subscription service can be received (410). The representations of the user input can include historic cancellation data including indicators of success of previously-performed customer saving procedures. A cancellation manager computing component managed by the first entity can receive (420) a cancellation request associated with a requesting computer-readable customer profile. The cancellation request can indicate that a subscription to the subscription service for the requesting customer profile is to be cancelled. After receiving (420) the cancellation request, the cancellation manager computing component can execute (430) a weighted algorithm to select a tailored customer saving procedure from among a plurality of available customer saving procedures. The weighted algorithm can utilize representations of the user input associated with the one or more customer profiles, including the historic cancellation data. Additionally, the plurality of available customer saving procedures can include the receiving customer saving procedures. The cancellation manager computing component can also perform (440) the selected tailored customer saving procedure. A result of the customer saving procedure may also be recorded in the historic cancellation data.

Additionally, the technique can include receiving rules from the second entity, where the rules govern the selection of the selected customer saving procedure. Moreover, a subscription manager computer component can receive subscription components to be provided under the subscription maybe received from the second entity. The subscription manager computing component can provide the subscription components to a customer associated with the requesting customer profile (e.g., by sending components to a client device, or by initiating sending of components in some other manner (entering a shipping request for physical goods to be sent, etc.). Alternatively, the second entity may provide the subscription components under the subscription to the customer associated with the requesting customer profile without the subscription components being handled by the first entity.

### IV. Example Content Page

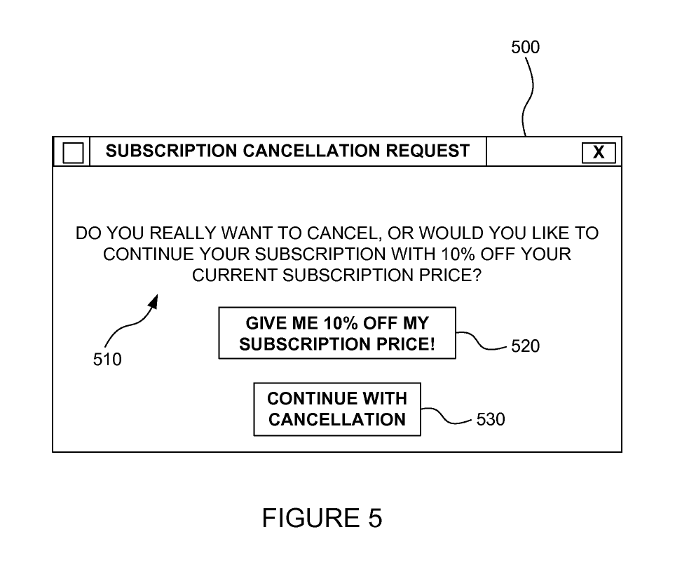

As discussed above, the tools and techniques discussed herein may be used with many different types of customer-saving content presentations, such as content pages. Additionally, a customer saving procedure may provide content grouped into one such content presentation or several such content presentations. An example of one such customer saving content page (500) is illustrated in FIG. 5. For example, the content page may be a page displayed as a Web page in a browser, or in a user interface of another mobile or desktop application, such as an application that is configured to allow a customer to manage one or more subscriptions. The content page (500) may be displayed on a display of a client device, such as the client devices (210) discussed above with reference to FIG. 2, and the content may be provided by a local or remote system, such as the primary provider computer system (230) of FIG. 2. The content page (500) can include a display (510) of information to persuade a customer to not cancel the subscription. In the illustrated example, this information calls attention to an incentive in the form of a reduced-price offer, asking “Do you really want to cancel, or would you like to continue your subscription with 10% off your current subscription price?” The content page (500) can also include controls. In the illustrated example, one control is an offer acceptance button (520) (stating “Give me 10% off my subscription price!”), which can be selected by user input to accept the offer of an incentive, or to start a procedure for accepting the incentive offer. The content page (500) can also include a control in the form of a cancellation continuation button (530) (stating “Continue with cancellation”), which can be selected by user input to continue the cancellation experience. For example, in response to selection of the cancellation continuation button, an additional customer-saving content page may be displayed, or a final cancellation confirmation page may be displayed (including a user interface control that can be selected to confirm cancellation of a subscription).

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

I/we claim:

1. A computer system comprising:
at least one processor; and
memory comprising instructions stored thereon that when executed by at least one processor cause at least one processor to perform acts comprising:
receiving representations of user input associated with one or more computer-readable customer profiles that are associated with a subscription service, the representations of the user input comprising historic cancellation data comprising indicators of success of previous performances of customer saving procedures of a set of available customer saving procedures;
detecting a potential upcoming cancellation of a subscription to the subscription service, the subscription being for a subject computer-readable customer profile;
after the detection of the potential upcoming cancellation, executing a weighted algorithm to select a tailored customer saving procedure from among a set of available customer saving procedures, the execution of the weighted algorithm utilizing the representations of the user input associated with the one or more customer profiles, including the historic cancellation data;
in response to the detection of the potential upcoming cancellation, performing the selected tailored customer saving procedure; and
recording a result of the selected tailored customer saving procedure in the historic cancellation data.

2. The computer system of claim 1, wherein the acts further comprise modifying execution of the weighted algorithm over time in response to additional results being recorded in the historic cancellation data.

3. The computer system of claim 1, wherein the selection of the selected tailored customer saving procedure is based at least in part on a measure of customer loyalty that is based at least in part on subscription usage data for the subject customer profile.

4. The computer system of claim 1, wherein:
the available customer saving procedures comprise content groupings, and a set of content items for each of the content groupings;
the set of content items for a grouping of the content groupings is customizable such that content for the grouping is selected from multiple different content options, with the selection of content depending on the computer-readable data; and
wherein performing the selected tailored customer saving procedure comprises sending the selected content in a format that is configured to be displayed as a page on a computer display.

5. The computer system of claim 4, wherein the selection of the selected tailored customer saving procedure comprises the weighted algorithm running to select the grouping and to select the content for the grouping.

6. The computer system of claim 1, wherein the representations of the user input associated with the one or more customer profiles comprises profile data for the subject customer profile.

7. The computer system of claim 6, wherein the profile data comprises usage data representing use of subscription components provided under the subscription.

8. The computer system of claim 1, wherein the representations of the user input associated with the one or more customer profiles comprise data representing past user input received in association with multiple customer profiles during customer saving procedures of the available customer saving procedures, the multiple customer profiles including customer profiles other than the subject customer profile.

9. The computer system of claim 1, wherein the acts further comprise collecting at least a portion of the representations of the user input associated with the one or more customer profiles by monitoring user input associated with the one or more customer profiles while the one or more customer profiles are using the subscription service.

10. The computer system of claim 1, wherein the acts are performed at least in part by hardware logic.

11. The computer system of claim 1, wherein the representations of the user input associated with the one or more customer profiles indicates subscription components of the subscription, which have been utilized in association with the subject customer profile and will no longer be available in association with the customer profile if the subscription is cancelled; and
performing the selected tailored customer saving procedure comprises providing content in a format that is configured to be displayed as a page on a computer display, the content indicating the utilized subscription components.

12. The computer system of claim 1, wherein performing the selected tailored customer saving procedure comprises offering the subject customer profile an incentive that includes a reduced subscription price if the subscription for the subject customer profile is not cancelled.

13. The computer system of claim 1, wherein performing the selected tailored customer saving procedure comprises offering the subject customer profile an incentive if the subscription is not cancelled, the incentive comprising additional subscription components that were not previously provided under the subscription for the subject customer profile.

14. The computer system of claim 1, wherein the representations of the user input associated with the one or more customer profiles comprise data representing user input received in association with the customer profile after the detection of the potential upcoming cancellation.

15. The computer system of claim 1, wherein the tailored customer saving procedure is a first tailored customer saving procedure, the set of available customer saving procedures is a first set of customer saving procedures, and the acts further comprise:
receiving a cancellation request in response to the first customer saving procedure; and
after receiving the cancellation request, performing the weighted algorithm to select a second tailored customer saving procedure from among the set of available customer saving procedures, the weighted algorithm utilizing the representations of the user input associated with one or more customer profiles to select the second tailored customer saving procedure; and
performing the selected second tailored customer saving procedure.

16. A computer-implemented method comprising:
receiving definitions of received customer saving procedures;
receiving representations of user input associated with one or more computer-readable customer profiles associated with a subscription service, the representations of the user input comprising historic cancellation data comprising indicators of success of previously-performed customer saving procedures;
detecting a potential upcoming cancellation of a subscription to the subscription service for a subject customer profile is to be cancelled;
after the detection of the potential upcoming cancellation, a cancellation manager computing component executing a weighted algorithm to select a tailored customer saving procedure from among a plurality of available customer saving procedures, the weighted algorithm utilizing the representations of the user input associated with the one or more customer profiles, including the historic cancellation data, and the plurality of available customer saving procedures comprising the received customer saving procedures;
the cancellation manager computing component performing the selected tailored customer saving procedure; and
recording a result of the customer saving procedure in the historic cancellation data.

17. The method of claim 16, further comprising receiving rules governing the selection of the selected customer saving procedure.

18. The method of claim 16, further comprising:
a subscription manager computer component receiving subscription components to be provided under the subscription; and
the subscription manager computer component providing the subscription components to a customer associated with the subject customer profile.

19. The method of claim 16, further comprising modifying execution of the weighted algorithm over time in response to additional results being recorded in the historic cancellation data.

20. A computer-implemented method comprising:
a procedure manager computing component managed by a first entity receiving definitions of received customer saving procedures from a second entity that is independent of the first entity;
the procedure manager computing component receiving rules from the second entity, the rules governing selection of customer saving procedures in response to cancellation requests;
receiving representations of user input associated with one or more computer-readable customer profiles associated with a subscription service, the representations of the user input comprising historic cancellation data comprising indicators of success of previously-performed customer saving procedures; and
a cancellation manager computing component managed by the first entity receiving a cancellation request associated with a requesting computer-readable customer profile, the cancellation request indicating a subscription for the requesting customer profile to the subscription service is to be cancelled;
after receiving the cancellation request, the cancellation manager computing component executing a weighted algorithm to select a tailored customer saving procedure from among a plurality of available customer saving procedures, the weighted algorithm utilizing computer-readable data representing the user input associated with the one or more customer profiles, the plurality of available customer saving procedures comprising the received customer saving procedures, the computer-readable data utilized by the weighted algorithm comprises usage data representing the requesting customer profile's use of subscription components provided under the subscription, and the computer-readable data utilized by the weighted algorithm comprises the historic cancellation data; and
in response to the cancellation request, the cancellation manager computing component performing the selected tailored customer saving procedure, the selected tailored customer saving procedure comprising sending content in response to the request to cancel in a format that is configured to be displayed as a page on a computer display.
